(19) United States
(12) Patent Application Publication
(10) Pub. No.: US 2018/0349953 A1
(43) Pub. Date: Dec. 6, 2018

(54) DIGITAL ACTIVITY ABANDONMENT

(71) Applicant: PayPal, Inc., San Jose, CA (US)

(72) Inventors: Cheng Tian, San Jose, CA (US); Michael Charles Todasco, Santa Clara, CA (US); Philip Chuang, San Mateo, CA (US); Prashanthi Ravanavarapu, Milpitas, CA (US); Aziz Jawadwala, San Jose, CA (US); Ashley Papagno, Santa Clara, CA (US); Anush Vishwanath, Santa Clara, CA (US)

(21) Appl. No.: 15/608,645

(22) Filed: May 30, 2017

(51) Int. Cl. G06Q 30/02

(52) U.S. Cl. CPC G06Q 30/0257; G06Q 30/0255; G06Q 30/0254; G06Q 30/0256; G06Q 30/0253

(57) ABSTRACT

A computer system determines that an item has been selected for purchase by a user on a user device. In response to determining that the item has been selected for purchase, the computer system determines that the purchase of the item was not completed. In response to determining that the purchase of the item was not completed, the computer system analyzes activity associated with the user device, and based on the analyzed activity, predicts whether the user intended to complete the purchase. In response to predicting that the user intended to complete the purchase, the computer system causes a communication corresponding to the item to be presented to the user.

### TECHNICAL FIELD

The present disclosure relates generally to digital activity, and more particularly to digital activity abandonment.

### BACKGROUND

In today's age, there is a wide range of digital distractions. In many cases, those digital distractions may interrupt an activity being performed by a user. For example, a user may place an item in an ecommerce shopping cart and may then continue onward with the purchase, or may alternatively navigate away from the ecommerce page to another page without completing the transaction. It can be valuable to identify the root cause for situations where a purchase is not carried out.

### BRIEF DESCRIPTION OF THE DRAWINGS

FIG. 1 illustrates a monitoring system, in accordance with an embodiment.

FIG. 2 is a flowchart illustrating the operations of the monitoring program of FIG. 1 in predicting whether a user intended to abandon a purchase, in accordance with an embodiment.

FIG. 3 is a flowchart illustrating the operations of the monitoring program of FIG. 1 in predicting whether a user intended to abandon an activity, in accordance with an embodiment.

FIG. 4 illustrates a display of the computing device of FIG. 1 during an interruption during a purchase check out, in accordance with an embodiment.

FIG. 5 illustrates a display of the computing device of FIG. 1 depicting a notification corresponding to completion of a purchase, in accordance with an embodiment.

FIG. 6 is a block diagram depicting the hardware components of the monitoring system of FIG. 1, in accordance with an embodiment.

### DETAILED DESCRIPTION

Embodiments of the present disclosure provide a system, method, and program product. A computer system determines that an item has been selected for purchase by a user on a user device. In response to determining that the item has been selected for purchase, the computer system determines that the purchase of the item was not completed. In response to determining that the purchase of the item was not completed, the computer system analyzes activity associated with the user device, and based on the analyzed activity, predicts whether the user intended to complete the purchase. In response to predicting that the user intended to complete the purchase, the computer system causes a communication corresponding to the item to be presented to the user.

In the example embodiment, the present disclosure describes a solution to the problem of purchase abandonment, such as shopping cart abandonment. In the example embodiment, the present disclosure describes a solution that involves predicting whether an item selected for purchase was intended to be abandoned. If the item was not intended to be abandoned, a communication may be transmitted or provided to the user associated with the purchase to remind the user to complete the purchase. This solution solves the problem faced by a user when an item, that is intended to be purchased, is left in a shopping cart and not purchased.

In addition, in the example embodiment, the present disclosure describes a solution to the problem of abandonment of a user activity that is intended to be completed. For example, a user may be reading an article when a digital distraction, such as a phone call or a text message, takes attention away from the article. The present disclosure provides a solution for predicting whether the user intended to complete the activity and if so, present a communication corresponding to the activity.

Embodiments of the present disclosure will now be described in detail with reference to the accompanying Figures.

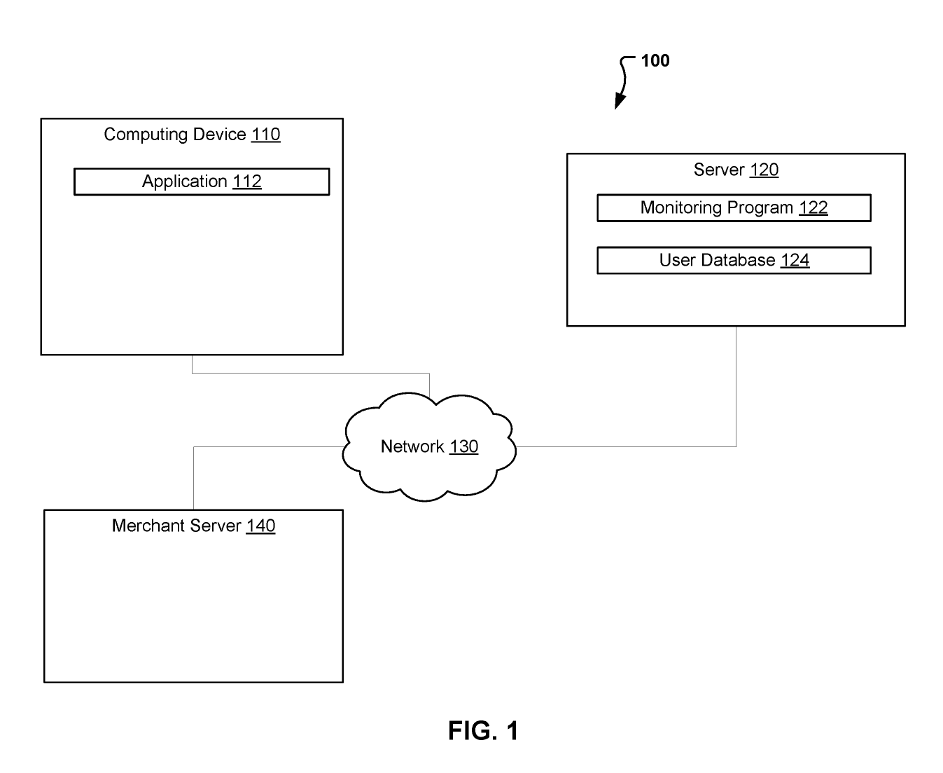

FIG. 1 illustrates monitoring system 100, in accordance with an embodiment. In an example embodiment, monitoring system 100 includes computing device 110, server 120, and merchant server 140 interconnected via network 130.

In the example embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between computing device 110, merchant server 140 and server 120.

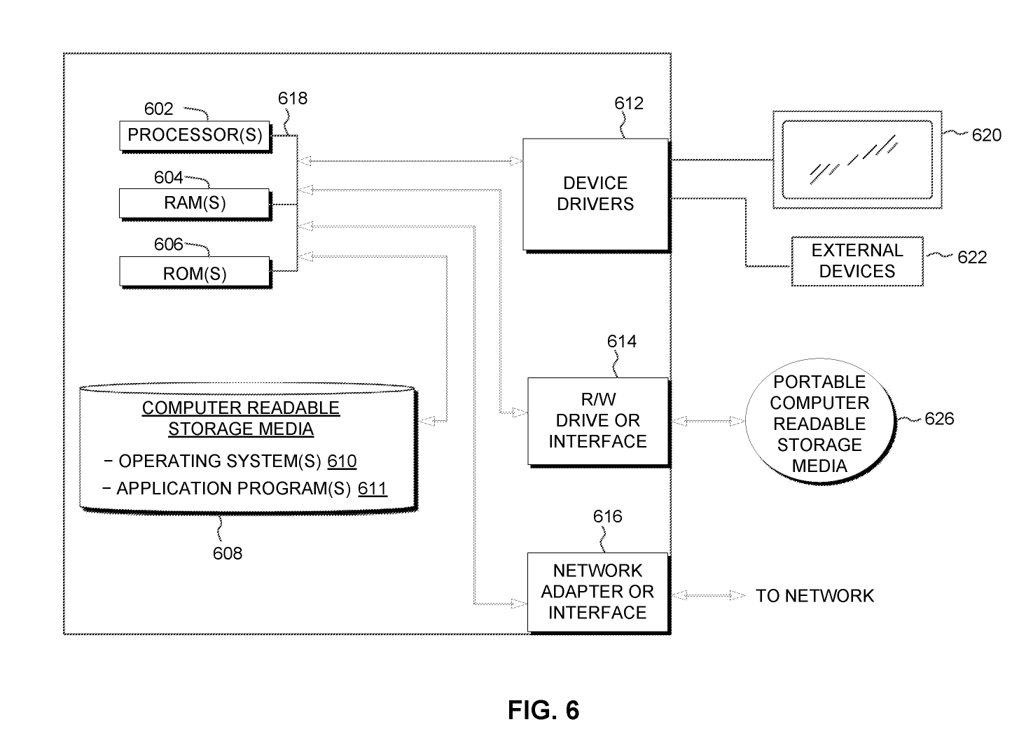

Merchant server 140 may be a desktop computer, a laptop computer, a tablet computer, a mobile device, a handheld device, a thin client, or any other electronic device or computing system capable of receiving and sending data to and from other computing devices, such as computing device 110, via network 130. In the example embodiment, merchant server 140 is a server that supports an online merchant web site, however, in other embodiments; merchant server 140 may be a server that supports a mobile application or a program. Merchant server 140 is described in more detail with reference to FIG. 6.

Computing device 110 includes application 112. In the example embodiment, computing device 110 is a mobile device such as a smartphone, however in other embodiments, computing device 110 may be a desktop computer, a laptop computer, a tablet computer, a handheld device, a thin client, or any other electronic device or computing system capable of receiving and sending data to and from other computing devices, such as server 120, via network 130. Computing device 110 is described in more detail with reference to FIG. 6.

In the example embodiment, application 112 is a program capable of enabling users to view, watch, or listen to documents and other resources, such as audio and video files, retrieved from a network device. In the example embodiment, application 112 is capable of requesting documents and other resources from a server, such as merchant server 140, via network 130. In the example embodiment, application 112 is a web browser, however in other embodiments; application 112 may be an ecommerce application capable of allowing the user to make purchases. In further embodiments, application 112 may be a mobile application, or another type of program.

Server 120 includes monitoring program 122 and user database 124. In the example embodiment, server 120 is a computing device capable of receiving and sending data to and from other computing devices, such as computing device 110, via a network, such as network 130. For example, server 120 may be a desktop computer, a laptop computer, a tablet computer, a handheld device, a smart-phone, a thin client, or any other electronic device or computing system capable of receiving and sending data to and from other computing devices. Server 120 is described in more detail with reference to FIG. 6.

User Database 124 includes information corresponding to one or more users. In the example embodiment, user database 124 includes information describing device activities of the one or more users. In the example embodiment, user database 124 may be populated based on information collected by monitoring program 122 while monitoring the one or more users. Furthermore, user database 124 may include information about the one or more users that may be utilized by monitoring program 122 to identify a digital activity routine, pattern and/or user habits corresponding to the one or more users. For example, user database 124 may include information describing activity routine information corresponding to the user of computing device 110, such as that the user logs onto a particular social media website every weekday during lunch. In another example, user database 124 may include information corresponding to an activity pattern corresponding to the user of computing device 110 such as information describing an amount of times that the user completes an ecommerce purchase that is interrupted by a call or text message. In further embodiments, user database 124 may include information corresponding to activity that takes place on devices of the user other than computing device 110 (which may be collected by monitoring program 122). For example, monitoring program 122 may in addition to monitoring user activities on computing device 110, monitor activity associated devices of the user (user activity, device activity, and/or environmental activity) listed in user database 124 as trusted devices.

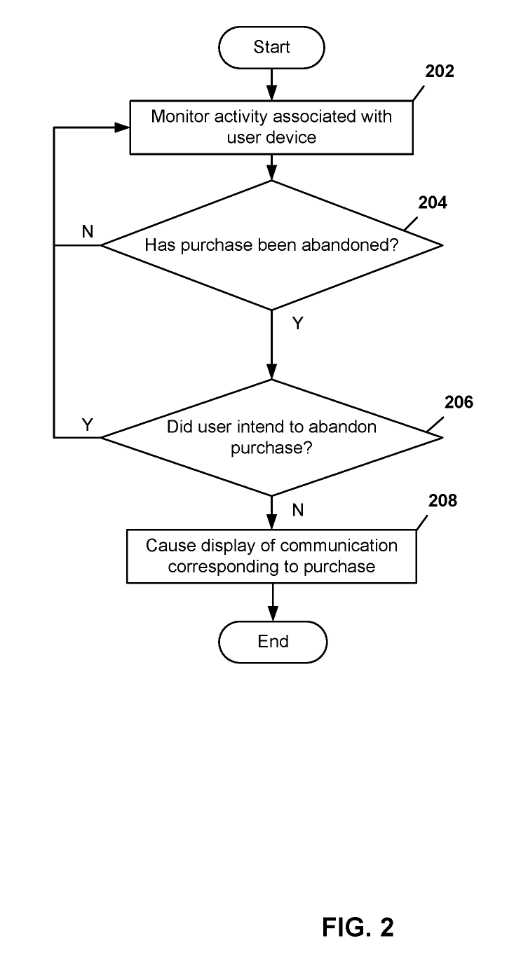

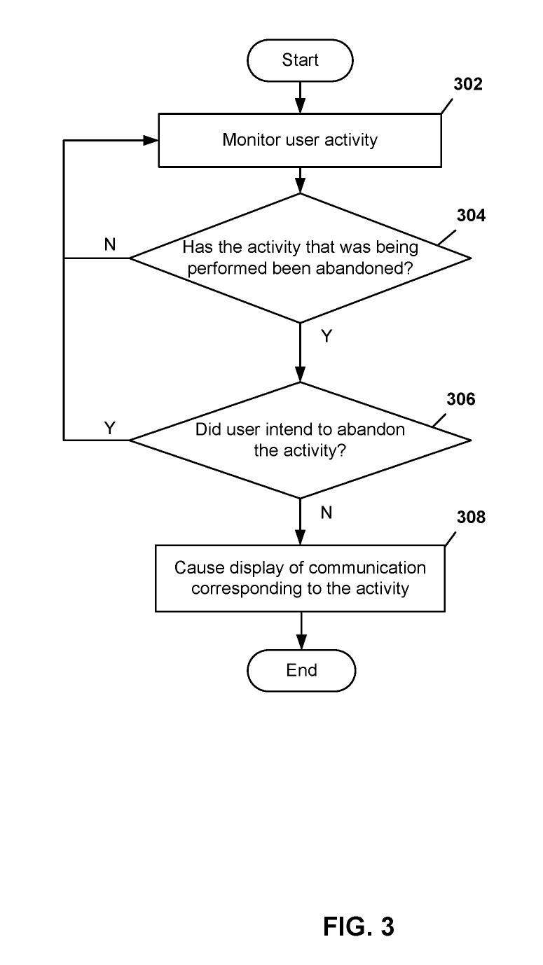

In the example embodiment, monitoring program 122 is a program capable of monitoring activity on another computing device, such as activity on computing device 110, by connecting with the computing device via network 130. In addition, monitoring program 122 is capable of accessing one or more components/modules of the monitored device, such as a microphone, a camera, a gyroscope, or additionally the operating system. In addition, monitoring program 122 is capable of updating user database 124 based on the collected monitored information. Furthermore, in the example embodiment, monitoring program 122 is capable of predicting whether a user intended to abandon an activity that was being performed on the user device by analyzing the monitored information. For example, monitoring program 122 may predict whether a user intended to abandon an ecommerce purchase or alternatively predict whether a user intended to abandon an article that was being viewed/read. In addition, in the example embodiment, monitoring program 122 is capable of presenting a communication corresponding to the abandoned activity to a device of the user based on the prediction. The operations of monitoring program 122 are described in further detail with reference to FIGS. 2 and 3.

FIG. 2 is a flowchart illustrating the operations of monitoring program 122 in predicting whether a user intended to abandon a purchase, in accordance with an embodiment.

In the example embodiment, monitoring program 122 monitors activity associated with computing device 110, such as user activity taking place in application 112 and other applications (step 202). In the example embodiment, monitoring program 122 may be triggered and begin monitoring activity associated with computing device 110 upon detection of application 112 being utilized to add an item to an ecommerce purchase flow, such as an ecommerce shopping cart or another type of ecommerce purchase or selection mechanism. For example, monitoring program 122 may be dormant or inactive, and upon detection, by monitoring program 122 or an alternative program on computing device 110 (such as the operating system), of application 112 being utilized to add an item to an ecommerce shopping cart by the user, monitoring program 122 may become active and begin monitoring user activity on computing device 110. In the example embodiment, along with monitoring user activity, monitoring activity associated with computing device 110 may also include monitoring device activity, such as battery life, wireless connectivity, incoming calls/texts, etc., and may further include utilizing device components and modules (such as a microphone, camera, etc.) to monitor environmental activity, such as ambient noises, user speech, speech by people other than the user of computing device 110, ringtones, vibrations, and additional environmental activity.

In other embodiments, monitoring program 122 may be triggered and begin monitoring activity associated with computing device 110 upon detection of application 112 being launched, or alternatively, monitoring program 122 may be triggered and begin monitoring upon detection that an ecommerce web site has been launched within application 112. For example, monitoring program 122 may be dormant or inactive, and upon detection, by monitoring program 122 or an alternative program, such as for example the operating system on computing device 110, of an ecommerce website being accessed via application 112, monitoring program 122 may begin monitoring activity associated with computing device 110. In further embodiments, monitoring program 122 may constantly monitor activity associated with computing device 110 while the device is running.

Monitoring program 122 determines whether the purchase corresponding to the item added to the ecommerce purchase flow has been abandoned (decision 204). In the example embodiment, monitoring program 122 determines whether the purchase corresponding to the item (or items) added to the ecommerce purchase flow has been abandoned based on analyzing the amount of time the item has been in the ecommerce purchase flow. For example, monitoring program 122 may monitor user activity and determine that the item has remained in an ecommerce shopping cart, with a purchase being made, for a period of time. Monitoring program 122 compares the period of time the item has remained in the ecommerce shopping cart to a threshold period of time, and if the period of time the item has remained in the ecommerce shopping cart exceeds the threshold period of time, monitoring program 122 determines that the purchase corresponding to the item has been abandoned.

In other embodiments, monitoring program 122 may determine whether the purchase corresponding to the item (or items) added to the ecommerce purchase flow has been abandoned based on analyzing the activity associated with computing device 110 (i.e., user activity, device activity, and/or environmental activity). For example, if monitoring program 122 identifies based on analyzing the user activity that the user of computing device 110 has navigated away from application 112 for longer than a threshold period of time, or that application 112 has been closed by the user and has not been reopened within a certain period of time, monitoring program 122 determines that the purchase corresponding to the item added to the ecommerce purchase flow has been abandoned. In another example, if monitoring program 122 identifies based on analyzing device activity that computing device 110 shut off due to low battery power prior to complete of the ecommerce purchase, monitoring program 122 may determine that the purchase corresponding to the item added to the ecommerce purchase flow has been abandoned.

If monitoring program 122 determines that the purchase corresponding to the item added to the ecommerce purchase flow was not abandoned (decision 204, “NO” branch), monitoring program 122 continues monitoring activity associated with computing device 110 (step 202). In other embodiments, rather than continuing to monitor activity associated with computing device 110, monitoring program 122 may revert to an inactive or dormant mode until the program is triggered in the manner stated above.

If monitoring program 122 determines that the purchase corresponding to the item added to the ecommerce purchase flow has been abandoned (decision 204, “YES branch”), monitoring program 122 predicts whether the user of computing device 110 intended to abandon the purchase of the item by analyzing the activity associated with computing device 110 (decision 206). As stated above, in the example embodiment, the activity associated with computing device 110 includes user activity, device activity, and environmental activity, however, in other embodiments, the activity associated with computing device 110 may include additional activity corresponding to computing device 110, and further activity by the user of computing device 110 collected from other servers (such as a merchant server). For example, monitoring program 122 may analyze user activity and determine that the user of computing device 110 received a message while in the process of completing an ecommerce purchase, and further determine that the user navigated to the message and did not complete the ecommerce purchase. In this example, monitoring program 122 may predict that the user of computing device 110 did not intend to abandon the purchase of the item. Furthermore, monitoring program 122 may reference user database 124 and identify patterns corresponding to how often that the user of computing device 110 completes an ecommerce purchase when the purchase is interrupted by a message. Monitoring program 122 may then determine a prediction based on the identified pattern corresponding to the user of computing device 110. For example, if monitoring program 122 determines that the user of computing device 110 typically completes an ecommerce purchase 85% of the time when interrupted by a message, monitoring program 122 may predict that the user of computing device 110 intended to complete the ecommerce purchase. In this example, monitoring program 122 may compare the percentage that the user typically completes an ecommerce purchase (85%) to a threshold percentage in order to determine the prediction. If the percentage the user typically completes the ecommerce purchase meets or exceeds the threshold percentage, monitoring program 122 may predict that the user of computing device 110 intended to complete the ecommerce purchase.

In another example, monitoring program 122 may analyze user activity and determine that the user of computing device 110 navigated to another website, without being provoked (such as by a popup), and did not complete the ecommerce purchase. In this example, monitoring program 122 may predict that the user of computing device 110 did intend to abandon the purchase of the item. Furthermore, as stated above, monitoring program 122 may take user patterns and additional information about the user stored in user database 124 into account as well in determining a prediction.

In another example, monitoring program 122 may analyze device activity associated with computing device 110 and determine that the battery level of computing device 110 led to a shutoff of the device prior to completion of the ecommerce purchase. In this example, monitoring program 122 may predict that the user of computing device 110 did not intend to abandon the purchase of the item. Alternatively, monitoring program 122 may access an operating system of computing device 110 to identify that a lack of network connectivity or a mobile signal led to the ecommerce purchase to be abandoned, in which case monitoring program 122 may determine that the user of computing device 110 did not intend to abandon the purchase of the item.

In a further example, monitoring program 122 may access device components of computing device 110 (such as the accelerometer) and determine that device was dropped during the process of the ecommerce purchase, which led to the purchase being abandoned. In this example, monitoring program 122 may predict that the user of computing device 110 did not intend to abandon the purchase of the item. In another example, monitoring program 122 may access device components of computing device 110 (such as a microphone or camera) to capture environmental activity, such as user speech, speech of people in the environment, ambient noises, gestures, and additional information, and predict based on the environmental activity, whether the user intended to abandon the purchase of the item. For example, monitoring program 122 may access the microphone, capture/analyze user speech, and determine that the user is talking about buying the item from a different merchant. In this example, monitoring program 122 may predict that the user of computing device 110 intended to abandon the purchase of the item.

In yet another example, monitoring program 122 may analyze a combination of user activity, device activity, and environmental activity in predicting whether the user of computing device 110 intended to abandon the ecommerce purchase. For example, monitoring program 122 may analyze user activity and determine that the user of computing device 110 navigated to a merchant competitor's web site, without being provoked (such as by a popup), and did not complete the ecommerce purchase (in process on a first merchant website). Monitoring program 122 may further access device components and capture user speech discussing the price for the item associated with the ecommerce purchase being the best on the first website. In this example, monitoring program 122 may predict that the user of computing device 110 did not intend to abandon the purchase of the item.

In a further example, monitoring program 122 may predict whether the user of computing device 110 intended to abandon the purchase of the item by utilizing information associated with the demographic of the user. For example, monitoring program 122 may utilize user information for a demographic of users that share similarities with the user (such as age, gender, socioeconomic status, etc.), and create a model corresponding to the user of computing device 110. Monitoring program 122 may then utilize the model to predict whether the user of computing device 110 intended to abandon the purchase of the item.

The examples above are not an exhaustive list of activities associated with the computing device that may be analyzed by monitoring program 122 to predict whether the user of computing device 110 intended to abandon the purchase of the item, but rather are intended to be illustrative examples. In addition, as stated above, monitoring program 122 may take user patterns and additional information about the user stored in user database 124 into account as well in determining a prediction.

If monitoring program 122 predicts that the user of computing device 110 intended to abandon the purchase of the item (decision 206, “YES” branch), monitoring program 122 continues to monitor activity associated with computing device 110 (step 202). In other embodiments, rather than continuing to monitor activity associated with computing device 110, monitoring program 122 may revert to an inactive or dormant mode until the program is triggered in the manner stated above.

If monitoring program 122 predicts that the user of computing device 110 did not intend to abandon the purchase of the item (decision 206, “NO” branch), monitoring program 122 causes display of a communication corresponding to the purchase to be presented to the user of computing device 110 (step 208). In the example embodiment, the communication is a notification or reminder to complete the purchase of the item, however, in other embodiments; the communication may be a coupon or targeted advertisement corresponding to the item. For example, if monitoring program 122 determines that the ecommerce purchase of the item was interrupted because the user of computing device 110 navigated to a merchant competitor's website, monitoring program 122 may transmit a communication to computing device 110 or cause a communication to be presented to the user of computing device 110 that includes a coupon or targeted advertisement to incentivize completion of the interrupted purchase.

Furthermore, in the example embodiment, monitoring program 122 may determine a communication platform or medium to cause display of the communication based on referencing user database 124. In the example embodiment, monitoring program 122 identifies a pattern of usage corresponding to the user of computing device 110 based on the information in user database 124, and identifies a time and a communication platform or medium to present the communication. For example, monitoring program 122 may reference user database 124 and identify, based on the information (such as historical usage information) associated with the user of computing device 110 in user database 124, a pattern of usage that includes the user logging into a specific social media app every morning. Therefore, in this example, monitoring program 122 may cause the communication to be presented to the user in the specific social media app, for example, in the user's morning social media feed, or via a social media message.

While in the example embodiment, FIG. 2 describes monitoring program 122 determining whether the purchase corresponding to the item added to the ecommerce purchase flow has been abandoned, and if the purchase was abandoned, determining whether the user intended to abandon the purchase, in other embodiments, the process may also be applicable for any purchases (and purchase flows) that utilize a user device. For example, the process may be applicable to an in store purchase flow (rather than an ecommerce purchase flow), where a user device is utilized for checkout. For example, if the user is in a physical store and adds an item to an in store purchase flow, by for example scanning a QR code, and then is interrupted (for example, in the manner described above), the process described above may be utilized to determine whether the user abandoned the purchase, and further whether the user intended to abandon the purchase of the item.

Furthermore, while in the example embodiment, monitoring program 122 causes a display of a communication corresponding to the purchase to be presented if monitoring program 122 predicts that the user of computing device 110 did not intend to abandon the purchase of the item, and continues to monitor activity associated with computing device 110 if monitoring program 122 predicts that the user of computing device 110 did intend to abandon the purchase, in other embodiments, monitoring program 122 may cause display of a communication corresponding to the purchase to be presented to the user of computing device 110 in both cases, with a different communication being caused to be displayed based on the prediction. For example, if monitoring program 122 predicts that the user of computing device 110 did not intend to abandon the purchase of the item, monitoring program 122 may cause a reminder (to complete the purchase) to be displayed to the user of computing device 110. Further, in this example, if monitoring program 122 predicts that the user of computing device 110 did intend to abandon the purchase of the item, monitoring program 122 may determine that additional incentive is required for the purchase to be completed and cause an offer or coupon to be presented to the user of computing device 110.

FIG. 3 is a flowchart illustrating the operations of monitoring program 122 in predicting whether a user intended to abandon an activity, in accordance with an embodiment.

In the example embodiment, monitoring program 122 monitors activity associated with computing device 110, such as user activity taking place in application 112 and other applications (step 302). In the example embodiment, monitoring program 122 may be triggered and begin monitoring activity associated with computing device 110 upon detection of application 112 being utilized to perform an activity, such as view an article or watch a video. For example, monitoring program 122 may be dormant or inactive, and upon detection, by monitoring program 122 or an alternative program on computing device 110 (such as the operating system), of application 112 being utilized by the user to perform an activity, monitoring program 122 may become active and begin monitoring user activity on computing device 110. In the example embodiment, along with monitoring user activity, monitoring activity associated with computing device 110 may also include monitoring device activity, such as battery life, wireless connectivity, incoming calls/texts, etc., and may further include utilizing device components and modules (such as a microphone, camera, etc.) to monitor environmental activity, such as ambient noises, user speech, speech by people other than the user of computing device 110, ringtones, vibrations, and additional environmental activity.

In other embodiments, monitoring program 122 may be triggered and begin monitoring activity associated with computing device 110 upon detection of application 112 being launched, or alternatively, monitoring program 122 may be triggered and begin monitoring upon detection that a resource from a predefined group of resources (such as a group of web sites) have been accessed using application 112. In further embodiments, monitoring program 122 may constantly monitor activity associated with computing device 110 while the device is running.

Monitoring program 122 determines whether the activity that was being performed has been abandoned (decision 304). In the example embodiment, monitoring program 122 determines whether the activity that was being performed has been abandoned based on detecting that the user of computing device 110 has navigated away from application 112 or alternatively has navigated to a different resource within application 112. For example, in an embodiment where application 112 is a web browser, monitoring program 122 may monitor user activity and determine that the user has navigated away from a first article on a website (the activity being performed) to another website or webpage prior to completing the first article, and therefore, determine that the activity that was being performed has been abandoned. In the example embodiment, monitoring program 122 may determine whether an activity that was being performed has been completed by tracking whether the entirety of resource has been scrolled through and further, may determine whether the activity that was being performed has been completed by utilizing a camera component of computing device 110 to track the gaze of a user with relation to the display screen. For example, if monitoring program 122 determines that an article (activity that was being performed) has not been scrolled through in its entirety, monitoring program 122 may determine that the activity that was being performed (the article) has not been completed. In another example, if monitoring program 122 determines that an article (activity that was being performed) has been scrolled through in its entirety, but based on tracking the gaze of the user, that the user has not viewed the article in its entirety, monitoring program 122 may determine that the activity that was being performed (the article) has not been completed.

In other embodiments, monitoring program 122 may determine whether the activity that was being performed has been abandoned based on analyzing activity associated with computing device 110 other than user activity (such as device activity, environmental activity, and/or activity by the user of computing device 110 collected from other servers, such as a merchant server). For example, if monitoring program 122 identifies based on analyzing device activity that computing device 110 shut off due to low battery power while the activity was being performed, monitoring program 122 may determine that the activity that was being performed has been abandoned. In another example, if monitoring program 122 identifies based on analyzing environmental activity, such as by accessing a microphone of computing device 110, that the user stated “this article is dumb” while the activity was being performed, monitoring program 122 may determine that the activity that was being performed (viewing the article) has been abandoned.

If monitoring program 122 determines that the activity that was being performed was not abandoned (decision 304, “NO” branch), monitoring program 122 continues monitoring activity associated with computing device 110 (step 302). In other embodiments, rather than continuing to monitor activity associated with computing device 110, monitoring program 122 may revert to an inactive or dormant mode until the program is triggered in the manner stated above.

If monitoring program 122 determines that the activity that was being performed has been abandoned (decision 204, “YES branch”), monitoring program 122 predicts whether the user of computing device 110 intended to abandon the activity that was being performed by analyzing the activity associated with computing device 110 (decision 306). As stated above, in the example embodiment, the activity associated with computing device 110 includes user activity, device activity, and environmental activity, however, in other embodiments, the activity associated with computing device 110 may include additional activity corresponding to computing device 110. For example, monitoring program 122 may analyze user activity and determine that the user of computing device 110 received a message while viewing an article, and further determine that the user navigated to the message and did not complete the article. In this example, monitoring program 122 may predict that the user of computing device 110 did not intend to abandon the activity that was being performed. Furthermore, monitoring program 122 may reference user database 124 and identify patterns corresponding to how often that the user of computing device 110 completes a specific activity, such as viewing an article, when the activity is interrupted by a message. Monitoring program 122 may then determine a prediction based on the identified pattern corresponding to the user of computing device 110. For example, if the interrupted activity is a financial news article, and, based on the data in user database 124, monitoring program 122 determines that the user of computing device 110 typically completes an article associated with the financial industry 85% of the time when interrupted by a message; monitoring program 122 may predict that the user of computing device 110 intended to complete the article. In this example, monitoring program 122 may compare the percentage that the user typically completes an article associated with the financial industry (85%) to a threshold percentage in order to determine the prediction. If the percentage the user typically completes an article associated with the financial industry meets or exceeds the threshold percentage, monitoring program 122 may predict that the user of computing device 110 intended to complete the article.

While, in the example above, monitoring program 122 utilized data in user database 124 that was associated with the specific activity that was being performed (viewing/completing a financial article) in order to determine a prediction, monitoring program 122 may instead utilize data in user database 124 that corresponds to the general activity being performed or alternatively to the type or category of interruption. For example, monitoring program 122 may utilize data in user database 124 corresponding to the percentage that the user typically completes an article in general when interrupted by a message, or alternatively utilize data in user database 124 corresponding to the percentage that the user typically completes an article in general when interrupted in general (whether it be a call, message, navigating away to another page, a popup, etc.). In another example, monitoring program 122 may utilize data in user database 124 corresponding to the percentage that the user typically completes an activity in general when interrupted by a message. For example, monitoring program 122 may reference user database 124 and determine that the user typically completes an activity that was being performed (such as an article, an email, a game, a purchase, etc.) 85% of the time when interrupted by a message. Monitoring program 122 may then compare the determined percentage (85%) to a threshold percentage, and if it meets or exceeds the threshold percentage, monitoring program 122 may predict that the user intended to complete the activity that was being performed. Alternatively, monitoring program 122 may utilize data in user database 124 corresponding to the percentage that the user typically completes an activity in general when interrupted in general (whether it be a call, message, navigating away to another page, a popup, etc.) in determining a prediction. While in the example embodiment, monitoring program 122 references data in user database 124 to determine a relevant percentage for the purposes of determining a prediction, in other embodiments, monitoring program 122 may utilize another form of data in determining a prediction (for example, an amount of times that the user has typically completed the activity when interrupted by a message).

In another example, monitoring program 122 may analyze user activity and determine that the user of computing device 110 navigated to another website or another application, without being provoked (such as by a popup), and did not complete the activity that was being performed (such as an article). In this example, monitoring program 122 may predict that the user of computing device 110 did intend to abandon the activity that was being performed. Furthermore, as stated above, monitoring program 122 may take user patterns and additional information about the user stored in user database 124 into account as well in determining a prediction.

In another example, monitoring program 122 may analyze device activity associated with computing device 110 and determine that the battery level of computing device 110 led to a shutoff of the device prior to completion of the activity that was being performed. In this example, monitoring program 122 may predict that the user of computing device 110 did not intend to abandon the activity that was being performed. Alternatively, monitoring program 122 may access an operating system of computing device 110 to identify that a lack of network connectivity or a mobile signal led to the abandonment of the activity that was being performed, in which case monitoring program 122 may determine that the user of computing device 110 did not intend to abandon the activity that was being performed.

In a further example, monitoring program 122 may access device components of computing device 110 (such as the accelerometer) and determine that device was dropped during the process of the performing the activity, which led to the performance of the activity being abandoned. In this example, monitoring program 122 may predict that the user of computing device 110 did not intend to abandon the activity that was being performed. In another example, monitoring program 122 may access device components of computing device 110 (such as a microphone or camera) to capture environmental activity, such as user speech, speech of people in the environment, ambient noises, gestures, and additional information, and predict based on the environmental activity, whether the user intended to abandon the activity that was being performed. For example, if the activity is viewing/reading an article, monitoring program 122 may access the microphone, capture/analyze user speech, and determine that the user speech includes the statement: “this article is terrible”. In this example, monitoring program 122 may predict that the user of computing device 110 intended to abandon the activity that was being performed.

In yet another example, monitoring program 122 may analyze a combination of user activity, device activity, and environmental activity in predicting whether the user of computing device 110 intended to abandon the activity that was being performed. For example, monitoring program 122 may analyze user activity and determine that the user of computing device 110 navigated away from the activity being performed (reading/viewing a first article) to, for example a second article, without being provoked (such as by a popup), and did not complete the first article. Monitoring program 122 may further access device components and capture user speech discussing topics brought up in the first article while viewing the second article or at a later time. In this example, monitoring program 122 may predict that the user of computing device 110 did not intend to abandon the activity that was being performed (the first article).

In a further example, monitoring program 122 may predict whether the user of computing device 110 intended to abandon the activity that was being performed by utilizing information associated with the demographic of the user. For example, monitoring program 122 may utilize user information for a demographic of users that share similarities with the user (such as age, gender, socioeconomic status, etc.), and create a model corresponding to the user of computing device 110. Monitoring program 122 may then utilize the model to predict whether the user of computing device 110 intended to abandon the activity that was being performed.

The examples above are not an exhaustive list of activities associated with the computing device that may be analyzed by monitoring program 122 to predict whether the user of computing device 110 intended to abandon the activity that was being performed, but rather are intended to be illustrative examples. In addition, as stated above, monitoring program 122 may take user patterns and additional information about the user stored in user database 124 into account as well in determining a prediction.

If monitoring program 122 predicts that the user of computing device 110 intended to abandon the activity that was being performed (decision 306, “YES” branch), monitoring program 122 continues to monitor activity associated with computing device 110 (step 302). In other embodiments, rather than continuing to monitor activity associated with computing device 110, monitoring program 122 may revert to an inactive or dormant mode until the program is triggered in the manner stated above.

If monitoring program 122 predicts that the user of computing device 110 did not intend to abandon the activity that was being performed (decision 306, “NO” branch), monitoring program 122 causes display of a communication corresponding to the activity that was being performed to computing device 110 (step 308). In the example embodiment, the communication is a notification or reminder to complete the activity, however, in other embodiments; the communication may be an incentive offer for completing the activity or a targeted advertisement corresponding to the activity.

Furthermore, in the example embodiment, monitoring program 122 may determine a communication platform or medium to cause display of the communication based on referencing user database 124. In the example embodiment, monitoring program 122 identifies a pattern of usage corresponding to the user of computing device 110 based on the information in user database 124, and identifies a time and a communication platform or medium to present the communication. For example, monitoring program 122 may reference user database 124 and identify, based on the information (such as historical usage information) associated with the user of computing device 110 in user database 124, a pattern of usage that includes the user utilizing a mobile device rather than computing device 110 during weekdays. If it is desired to transmit the communication during a weekday, monitoring program 122 may cause the communication to be presented to the user on the mobile device rather than computing device 110, for example, by way of transmitting a text message.

Furthermore, while in the example embodiment, monitoring program 122 causes a display of a communication corresponding to the activity that was being performed to be presented if monitoring program 122 predicts that the user of computing device 110 did not intend to abandon the purchase of the item, and continues to monitor activity associated with computing device 110 if monitoring program 122 predicts that the user of computing device 110 did intend to abandon the activity that was being performed, in other embodiments, monitoring program 122 may cause display of a communication corresponding to the activity that was being performed to be presented to the user of computing device 110 in both cases, with a different communication being caused to be displayed based on the prediction. For example, if monitoring program 122 predicts that the user of computing device 110 did not intend to abandon the activity that was being performed, monitoring program 122 may cause a reminder (to complete the activity) to be displayed to the user of computing device 110. Further, in this example, if monitoring program 122 predicts that the user of computing device 110 did intend to abandon the activity that was being performed, monitoring program 122 may determine that additional incentive is required for the activity to be completed and cause an offer, coupon, or incentive to be presented to the user of computing device 110 (for completion of the activity).

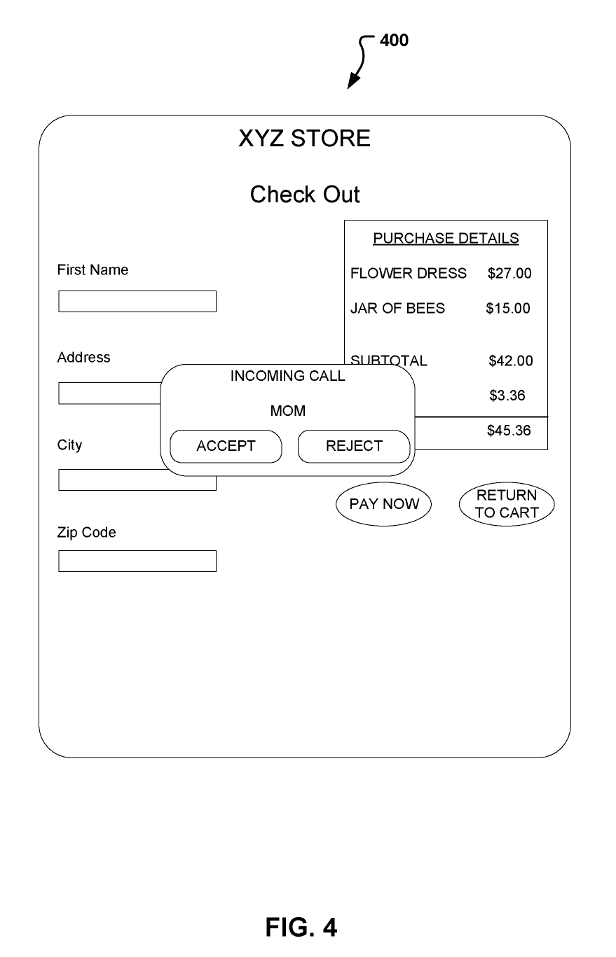

FIG. 4 illustrates display 400 of computing device 110, in accordance with an embodiment of the invention. In the example embodiment, display 400 depicts an illustration of an ecommerce purchase flow (such as an ecommerce shopping cart) on a merchant website that is interrupted by a phone call, prior to completion.

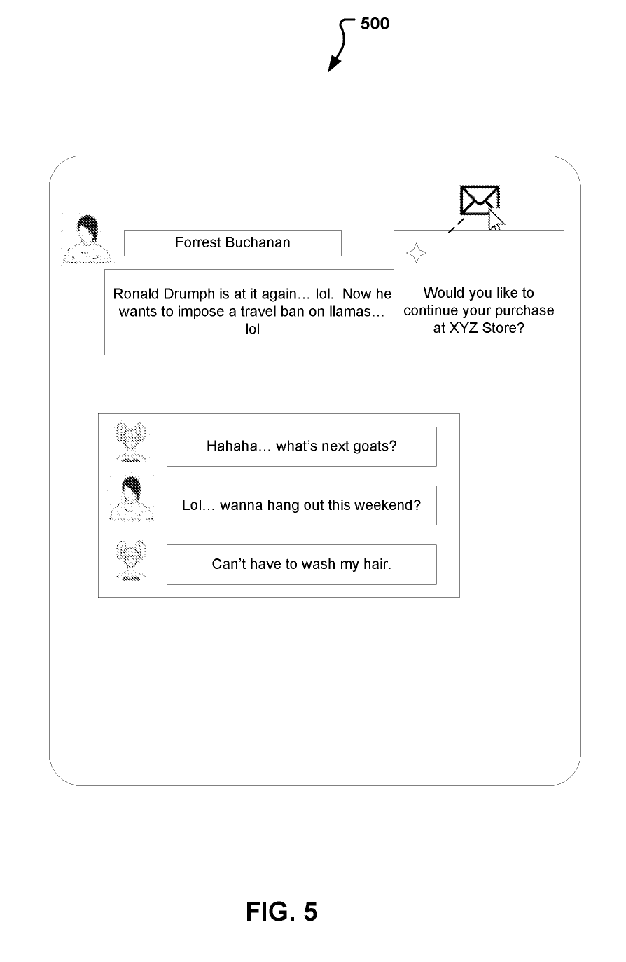

FIG. 5 illustrates display 500 of computing device 110, in accordance with an embodiment of the invention. In the example embodiment, display 500 depicts a social media application being utilized by the user of computing device 110, with the user further receiving a communication or notification corresponding to completion of an abandoned purchase. In the example embodiment, the communication was caused to be presented in response to monitoring program 122 predicting that the user did not intend to abandon the purchase. Furthermore, the communication is presented in the depicted social media application in response to monitoring program 122 identifying that the social media application is the appropriate communication platform to cause presentation of the communication based on referencing the information in user database 124, as described above.

The foregoing description of various embodiments of the present disclosure has been presented for purposes of illustration and description. It is not intended to be exhaustive nor to limit the disclosure to the precise form disclosed. Many modifications and variations are possible. Such modifications and variations that may be apparent to a person skilled in the art of the disclosure are intended to be included within the scope of the disclosure as defined by the accompanying claims.

FIG. 6 depicts a block diagram of components of computing devices contained in monitoring system 100 of FIG. 1, in accordance with an embodiment. It should be appreciated that FIG. 6 provides only an illustration of one implementation and does not imply any limitations with regard to the environments in which different embodiments may be implemented. Many modifications to the depicted environment may be made.

Computing devices may include one or more processors 602, one or more computer-readable RAMs 604, one or more computer-readable ROMs 606, one or more computer readable storage media 608, device drivers 612, read/write drive or interface 614, network adapter or interface 616, all interconnected over a communications fabric 618. Communications fabric 618 may be implemented with any architecture designed for passing data and/or control information between processors (such as microprocessors, communications and network processors, etc.), system memory, peripheral devices, and any other hardware components within a system.

One or more operating systems 610, and one or more application programs 611, for example, monitoring program 122, are stored on one or more of the computer readable storage media 608 for execution by one or more of the processors 602 and by utilizing one or more of the respective RAMs 604 (which typically include cache memory). In the illustrated embodiment, each of the computer readable storage media 608 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing devices may also include a R/W drive or interface 614 to read from and write to one or more portable computer readable storage media 626. Application programs 611 on the computing devices may be stored on one or more of the portable computer readable storage media 626, read via the respective R/W drive or interface 614 and loaded into the respective computer readable storage media 608.

Computing devices may also include a network adapter or interface 616, such as a TCP/IP adapter card or wireless communication adapter (such as a 4G wireless communication adapter using OFDMA technology). Application programs 611 on the computing devices may be downloaded to the computing devices from an external computer or external storage device via a network (for example, the Internet, a local area network or other wide area network or wireless network) and network adapter or interface 616. From the network adapter or interface 616, the programs may be loaded onto computer readable storage media 608. The network may comprise copper wires, optical fibers, wireless transmission, routers, firewalls, switches, gateway computers and/or edge servers.

Computing devices may also include a display screen 620, and external devices 622, which may include, for example a keyboard, a computer mouse and/or touchpad. Device drivers 612 interface to display screen 620 for imaging, to external devices 622, and/or to display screen 620 for pressure sensing of alphanumeric character entry and user selections. The device drivers 612, R/W drive or interface 614 and network adapter or interface 616 may comprise hardware and software (stored on computer readable storage media 608 and/or ROM 606).

The programs described herein are identified based upon the application for which they are implemented in a specific embodiment. However, it should be appreciated that any particular program nomenclature herein is used merely for convenience, and thus the disclosure should not be limited to use solely in any specific application identified and/or implied by such nomenclature.

Based on the foregoing, a computer system, method, and computer program product have been disclosed. However, numerous modifications and substitutions can be made without deviating from the scope of the present disclosure. Therefore, the various embodiments have been disclosed by way of example and not limitation.

Various embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system, comprising:
one or more processors and one or more computer-readable memories storing program instructions, the one or more processors configured to execute the program instructions to cause the system to perform the operations comprising:
determining that an item has been selected for purchase on a user device;
in response to the determining that the item has been selected for purchase, determining that purchase of the item was not completed;
in response to the determining that the purchase of the item was not completed, analyzing activity associated with the user device, and based on the analyzed activity, predicting whether a user associated with the user device intended to complete the purchase; and
in response to predicting that the user intended to complete the purchase, causing a communication corresponding to the item to be presented to the user.

2. The system of claim 1, the operations further comprising:
analyzing historical usage information associated with the user to identify a communication medium from a plurality of communication mediums to utilize for presentation of the communication; and
wherein the causing the communication corresponding to the item to be presented to the user includes causing the communication to be presented to the user via the identified communication medium.

3. The system of claim 1, the operations further comprising:
analyzing historical usage information associated with the user to identify a communication platform from a plurality of communication platforms to cause presentation of the communication; and
wherein the causing the communication corresponding to the item to be presented to the user includes causing the communication to be presented to the user via the identified communication platform.

4. The system of claim 1, the operations further comprising:
determining that the purchase of the item was interrupted by an interruption action of one or more types of interruption actions; and
wherein the analyzing the activity associated with the user device, and based on the analyzed activity, predicting whether the user intended to complete the purchase includes:
analyzing historical usage information associated with the user to identify one or more previous purchase flows associated with at least one interruption action of the one or more types of interruption actions;
determining an amount of the identified one or more previous purchase flows that resulted in a purchase; and
wherein the predicting whether the user intended to complete the purchase is based on the determined amount of the identified one or more previous purchase flows.

5. The system of claim 1, the operations further comprising:
determining that the purchase of the item was interrupted by a first type of interruption action of one or more types of interruption actions; and
wherein the analyzing the activity associated with the user device, and based on the analyzed activity, predicting whether the user intended to complete the purchase includes:
analyzing historical usage information associated with the user to identify one or more previous purchase flows associated with the first type of interruption action;
determining an amount of the identified one or more previous purchase flows that resulted in a purchase; and
wherein the predicting whether the user intended to complete the purchase is based on the determined amount of the identified one or more previous purchase flows.

6. The system of claim 1, wherein the analyzing the activity associated with the user device comprises analyzing user activity associated with the user device.

7. The system of claim 1, wherein the analyzing the activity associated with the user device comprises analyzing user device operations activity associated with the user device or analyzing environmental activity associated with an environment of the user device.

8. A method comprising:
determining that an user activity that was being performed on a user device has been abandoned;
in response to the determining that the user activity was abandoned, analyzing activity associated with the user device to predict whether a user of the user device intended to abandon the user activity; and
in response to predicting that the user did not intend to abandon the user activity, causing a communication corresponding to the user activity to be presented to the user.

9. The method of claim 8, further comprising:
analyzing historical usage information associated with the user to identify a communication medium from a plurality of communication mediums to utilize for presentation of the communication; and
wherein the causing the communication corresponding to the user activity to be presented to the user includes causing the communication to be presented to the user via the identified communication medium.

10. The method of claim 8, wherein the causing the communication corresponding to the user activity to be presented to the user includes transmitting a notification corresponding to the user activity to the user device.

11. The method of claim 8, further comprising:
determining that the user activity was interrupted by an interruption action of one or more types of interruption actions; and
wherein the analyzing the activity associated with the user device to predict whether the user intended to abandon the user activity includes:
analyzing historical usage information associated with the user to identify one or more previous user activities associated with at least one interruption action of the one or more types of interruption actions;
determining an amount of the identified one or more previous user activities that resulted in completion of the corresponding user activity; and
wherein the predicting whether the user intended to abandon the user activity is based on the determined amount of the identified one or more previous user activities.

12. The method of claim 8, the operations further comprising:
determining that the user activity was interrupted by a first type of interruption action of one or more types of interruption actions; and
wherein the analyzing the activity associated with the user device to predict whether the user intended to abandon the user activity includes:
analyzing historical usage information to identify one or more previous user activities associated with the first type of interruption action;
determining an amount of the identified one or more user activities that resulted in completion of the corresponding user activity; and
wherein the predicting whether the user intended to abandon the user activity is based on the determined amount of the identified one or more user activities.

13. The method of claim 8, wherein the causing the communication corresponding to the user activity to be presented to the user includes determining a type of the communication to present based on the activity associated with the user device.

14. The method of claim 8, wherein the analyzing the activity associated with the user device comprises analyzing user activity subsequent to abandonment of the user activity, analyzing user device operations activity, analyzing environmental activity associated with an environment of the user device, or a combination thereof.

15. A computer program product, comprising:
one or more computer-readable tangible storage devices, and program instructions stored on at least one of the one or more computer-readable tangible storage devices, the program instructions when executed cause a machine to perform operations comprising:
determining that an item has been added to a purchase flow on a user device;
in response to the determining that the item has been added to the purchase flow, determining that the purchase of the item was abandoned;
in response to the determining that the purchase of the item was abandoned, analyzing activity associated with the user device to predict whether a user of the user device intended to abandon the purchase; and
in response to predicting that the user did not intend to abandon the purchase, causing a communication corresponding to the item to be presented to the user.

16. The computer program product of claim 15, the operations further comprising:
analyzing historical usage information associated with the user to identify a communication medium from a plurality of communication mediums to utilize for presentation of the communication; and
wherein the causing the communication corresponding to the item to be presented to the user includes causing the communication to be presented to the user via the identified communication medium.

17. The computer program product of claim 15, wherein the causing the communication corresponding to the item to be presented to the user includes transmitting a notification to the user device.

18. The computer program product of claim 15, further comprising:
determining that the purchase of the item was interrupted by an interruption action of one or more types of interruption actions; and
wherein the analyzing the activity associated with the user device to predict whether the user intended to abandon the purchase includes:
analyzing historical usage information associated with the user to identify one or more previous purchase flows associated with at least one interruption action of the one or more types of interruption actions;
determining an amount of the identified one or more previous purchase flows that resulted in a purchase; and
wherein the predicting whether the user intended to abandon the purchase is based on the determined amount of the identified one or more previous purchase flows.

19. The computer program product of claim 15, wherein the causing the communication corresponding to the item to be presented to the user includes determining a type of the communication to present based on the activity associated with the user device.

20. The method of claim 9, wherein the analyzing the activity associated with the user device comprises analyzing user activity associated with the user device, analyzing device operations activity associated with the user device, analyzing environmental activity associated with an environment of the user device, or a combination thereof.
